(19) United States
(12) Patent Application Publication
(10) Pub. No.: US 2005/0237906 A1
(43) Pub. Date: Oct. 27, 2005

(54) High density data storage

(76) Inventor: Gary A. Gibson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/833,604

(22) Filed: Apr. 27, 2004

(51) Int. Cl. G11B 9/00

(52) U.S. Cl. 369/126

(57) ABSTRACT

The present invention includes a method and apparatus for storing data. Accordingly, a first aspect of the present invention is a data storage device. The data storage device includes a probe tip, a data storage medium proximate to the probe tip and a pyroelectric sensing mechanism for sensing a displacement of the probe tip relative to the data storage medium.

### FIELD OF THE INVENTION

The present invention relates generally to data storage media and more particularly to a data storage device and a method of reading data in a data storage device.

### BACKGROUND OF THE INVENTION

Storage media for computers and other types of electronic devices generally come in two types: volatile memory and non-volatile memory. Volatile memory loses its contents when power is no longer being supplied to the memory, whereas non-volatile memory maintains its contents even when power is not being supplied to the memory. The most common type of volatile memory is volatile random-access memory (RAM), which is most commonly available as and implemented as an integrated circuit (IC). The term data storage medium is used herein in a broad sense, and encompasses IC memory, as well as other types of data storage media.

By comparison, non-volatile memory has perhaps more commonly been available as and implemented as magnetic and optical media, including hard disk drives, floppy disks, compact disc read-only memories (CD-ROM's), CD re-writable (CD-RW) discs, and digital versatile discs (DVD's), among others. Historically, non-volatile memory implemented as an IC was primarily available as ROM that was not re-recordable, such as hard-wired ROM and programmable ROM (PROM). More recently, IC non-volatile memory has become available as various types of flash memory, which is more technically known as electrically erasable PROM (EEPROM).

It is a general aim for the computer industry to increase the storage density of the storage media being used by computers. Every new technology, however, should offer long-term perspectives in order to give room for continued improvements within the new technology. This is due to the fact that with every fundamental change of storage technology, the computer industry has to undertake remarkable investments in order to adapt existing production machines or to replace existing machines by new ones for any technical purpose involved with said new technology. Thus, the consequence for further development of storage systems is that any new technique with better storage area density should have a long-term potential for further scaling, desirably down to the nanometer or even atomic scale.

The only available tool known today that is simple and yet provides these long-term perspectives is a nanometer probe tip. Such tips are used in every atomic force microscope (AFM) and scanning tunneling microscope (STM) for imaging and structuring down to the atomic scale. The simple tip is a very reliable tool that concentrates on one functionality: the ultimate local confinement of interaction. In recent years, AFM thermo-mechanical recording in polymer storage media has undergone extensive modifications mainly with respect to the integration of sensors and heaters designed to enhance simplicity and to increase data rate and storage density.

Such prior art thermo-mechanical writing is a combination of applying a local force by the cantilever/tip to a polymer layer and softening it by local heating. By applying sufficient heat an indentation can be formed into the storage medium for writing a bit which can be read back with the same tip, by the fact that the lever is bent when it is moved into the indentation and the electrical resistance of a sensing circuit is changed therewith.

While writing data or bits, the heat transfer from the tip to the polymer through the small contact area is initially very poor and improves as the contact area increases. This means the tip must be heated to a relatively high temperature to initiate the melting process. Once melting has commenced, the tip is pressed into the polymer, which increases the heat transfer to the polymer, increases the volume of melted polymer, and hence increases the bit size. After melting has started and the contact area has increased, the heating power available for generating the indentations increases by at least ten times to become 2% or more of the total heating power (depending on the design). Once the bits are written, it is crucial that the read process is conducted as efficiently as possible.

Accordingly, what is needed is a method and system that is capable of reading these bits in an efficient and expeditious fashion. The method and system should be simple and capable of being easily adapted to existing technology. The present invention addresses these needs.

### SUMMARY OF THE INVENTION

The present invention includes a data storage device and a method of reading data in a data storage device. Accordingly, a first aspect of the present invention is a data storage device. The data storage device includes a probe tip, a data storage medium proximate to the probe tip and a pyroelectric sensing mechanism for sensing a displacement of the probe tip relative to the data storage medium.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method in accordance with an embodiment of the present invention.

FIG. 2 is an illustration of a data storage system in accordance with an embodiment of the present invention.

FIG. 3 is a schematic view of the data storage system in accordance with an embodiment of the present invention.

FIG. 4 shows a data storage system in accordance with an alternate embodiment of the present invention.

FIG. 5 shows a data storage system in accordance with an alternate embodiment of the present invention.

FIG. 6 shows a computer system in accordance with another embodiment of the present invention.

### DETAILED DESCRIPTION OF THE INVENTION

The present invention relates to a data storage device and a method of reading data in a data storage device. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

Based on varying embodiments, a data storage device and a method of reading data in a data storage device are disclosed. Accordingly, a pyroelectric sensing mechanism is implemented within the data storage device in conjunction with a probe tip. As the probe tip is scanned over a data storage medium, a gap between portions of the probe-tip's suspension and the underlying storage medium varies as the tip encounters bits in the storage medium. As the gap between the portions of the probe-tip's suspension and the underlying storage medium changes, a monitorable change in temperature of portions of the probe-tip's suspension can be detected by utilizing the pyroelectric sensing mechanism. These temperature changes occur because the net thermal conductance between these portions of the probe-tip's suspension and the rest of the device, changes as the probe-tip traverses the data storage medium and encounters bits therein.

During the reading process, a heater mounted on the suspension heats the suspension. The temperature at which various portions of the suspension and probe-tip comes to equilibrium is determined by the thermal coupling of the probe-tip and suspension to the rest of the device. If, for example, the tip drops into a bit that is recorded in the form of a depression on the surface of the storage medium, then portions of the probe-tip's suspension move closer to the storage medium. This can increase the thermal conductivity between these portions of the probe-tip's suspension and the storage medium via any gas molecules present between the suspension and the storage medium. This increased thermal conductivity results in a reduced ability of the heating element to hold the suspension at an elevated temperature. Consequently, the temperature of the suspension drops by a measurable amount. Accordingly, a readout scheme can be implemented whereby the change in temperature and, thereby, the presence of bits in the data storage medium, is monitored by the pyroelectric sensing mechanism.

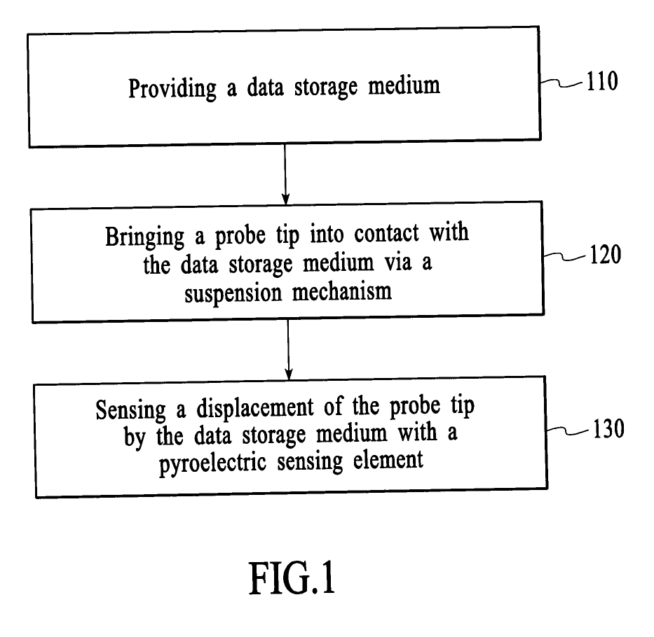

FIG. 1 shows a high-level flowchart of a method in accordance with an embodiment. A first step 110 involves providing a data storage medium. A second step 120 involves bringing a probe tip mounted on a flexible suspension into contact with the storage medium. A final step 130 includes sensing a displacement of the probe tip by the data storage medium with a pyroelectric sensing element. In an embodiment, a displacement of the probe tip is sensed when the probe tip encounters a bit in the topography of the data storage medium.

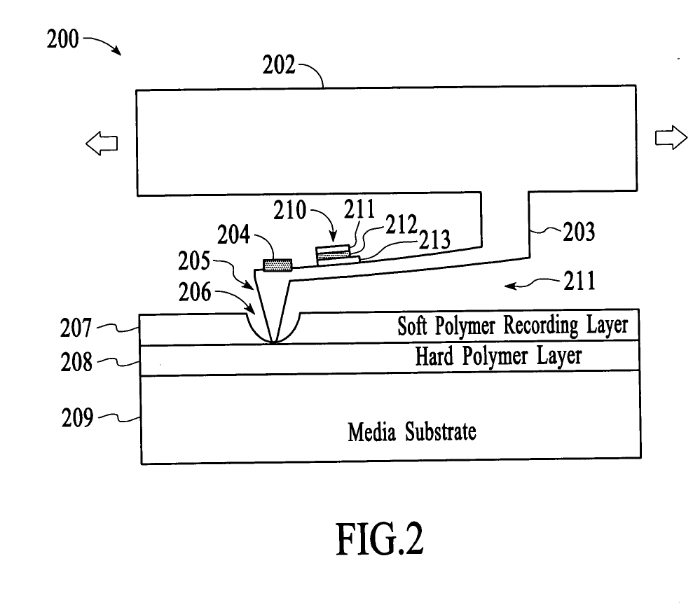

FIG. 2 is an illustration of a system 200 for storing data in accordance with an embodiment. The system 200 includes a suspension mechanism 202 that includes a cantilever 203. A probe tip 205 is coupled to the cantilever 203. The system 200 also includes two polymer layers 207, 208. The first polymer layer 207 serves as a data storage medium whereby data is stored on the first polymer layer 207 in the form of a bit 206. The second polymer layer 208 acts to limit the depth of the bit(s) 206 in the first polymer layer 207. In an embodiment, the first polymer layer 207 is a soft polymer layer (e.g. polymethylmethacrylate) whereas the second polymer layer 208 is harder (e.g. SU8). Although the second polymer layer 208 is somewhat harder than the first polymer layer 207, the second polymer layer 208 should still be soft enough to help protect the probe tip 205 from wear and shock. The harder layer 208 is deposited upon a substrate 209 such as silicon.

The system 200 also includes a heater 204 and pyroelectric sensing mechanism 210. The pyroelectric sensing mechanism 210 includes a top conductor 211, a pyroelectric element 212 and a bottom conductor 213. A pyroelectric element 212 is a material that exhibits a voltage difference between opposite crystal faces wherein the voltage difference is temperature dependent. Example pyroelectric materials include lithium tantalite (LiTaO₃) and lithium niobate (LiNbO₃). In an embodiment, the sensing mechanism 210 is built by depositing a layer of conducting material (bottom contact), growing a layer of pyroelectric material on top of the bottom contact and then depositing a top contact onto the pyroelectric material. Additional isolation layers/masks may be implemented to prevent shorting of the pyroelectric layer and the traces connected thereto.

Data is read from the first polymer layer 207 by scanning the probe tip 205 over the data storage medium 207 wherein the heater 204 operates at a power too low to cause any writing or erasing in the data storage medium 207. As the probe tip 205 is scanned over the data storage medium 207, the probe tip 205 encounters a bit 206 whereby the tip 205 is displaced by the bit 206. A bit 206 can be a pit a hill or any other change in the topography of the data storage medium 207. When the gap between the probe tip 205 and the substrate 209 decreases, for example, when the probe tip 205 encounters a bit 206, variations in the thermal coupling between the probe tip 205 and the data storage medium 207 are caused that affect the temperature of probe tip 205. These temperature variations cause a voltage to be induced across the pyroelectric sensing mechanism 210.

Consequently, each temperature variation, i.e. each bit 206, can be detected by monitoring the voltage that is induced across the pyroelectric sensing mechanism 210. This is due to the fact that the thermal conductance of an exchange gas (not shown) between the cantilever 203 and the storage medium 207 has a non-linear dependence on the gap 210. Accordingly, when the size of the gap 210 changes, the temperature changes since the temperature depends on the exchange gas' thermal conductance, as well as the thermal conductance of the cantilever 203.

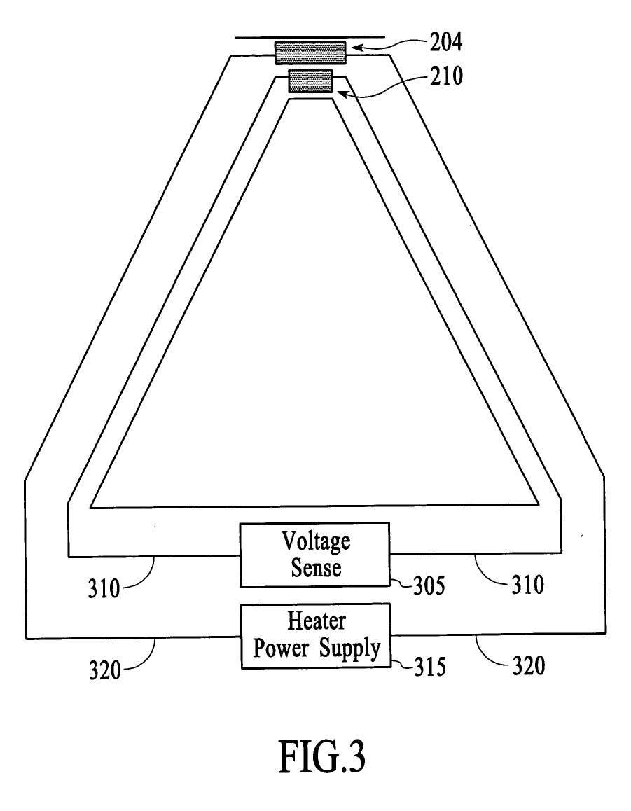

FIG. 3 shows one possible configuration of an embodiment of the data storage device. Shown in FIG. 3 are the heater element 204 and the pyroelectric sensing mechanism 210 (same as FIG. 2), a voltage sensor 305 and a heater power supply 315. The voltage sensor 305 is coupled to the pyroelectric sensing mechanism 210 via conducting path 310 and the heater power supply 315 is coupled to the heater element 204 via conducting path 320. In an embodiment, the heater power supply 315 is on the suspension 202 that supports the cantilever 203. The voltage sensor 305 could be placed on the cantilever 203 if necessary to improve the signal-to-noise ratio. Otherwise, the voltage sensor 305 is placed on the suspension mechanism 202 near the cantilever 203 in order to facilitate an easier fabrication of the cantilever 203.

The conducting paths 310, 320 can be implemented through combinations of doping conducting channels in a resistive cantilever material (e.g. undoped or lightly doped Si) or doping an insulating barrier or trench between conducting paths in a conducting cantilever material (e.g. more heavily doped Si), or physically isolating the conducting paths 310, 320 by etching slots along the length of the cantilever 203. It should be noted with regard to the conducting path(s) 310, one of the paths is connected to a top contact of the pyroelectric sensing mechanism 210 and the other path is connected to a bottom contact of the pyroelectric sensing mechanism 210.

It should be noted that the data storage system can be designed whereby the vertical motion of the cantilever 203 relative to the storage medium 207 has a larger impact on the temperature change. This is accomplished by properly selecting the geometries of the system. The proper choice of ambient exchange gas and gas pressure can also maximize the impact of temperature changes in the gap 210 between the tip 205 and the substrate 209 on the thermal conductance thereby producing larger signals.

It should be noted the above-described scheme can be employed with any storage medium in which bits are stored topographically. Accordingly, the data storage medium can be any material or set of materials in which bits can be stored topographically. The bits can be either pits or protrusions, or combinations of both and written by means other than thermal writing. Additionally, multiple probe tips and storage regions can be used in parallel to achieve higher data read and write rates.

The size, shape and material properties of the probe suspension should be consistent with the desired mechanical properties of the suspension which, in many cases, are dictated by requirements on bandwidth, tip/media loading force, dynamic range, etc. The power required for readout can be reduced if temperature changes of the probe/pyroelectric element can be detected with a better signal-to-noise ratio (SNR). A better SNR allows for the use of lower heater power during read operations. The signal V developed across a pyroelectric film is approximately:
V=4*pi*d*p*ΔT/ε (1)

Where d is the film thickness, ΔT is the change in temperature, ε is the dielectric constant, and p is the pyroelectric constant. For lithium tantalite, p=23 nC/cm²-K and ε˜44. Thus, for reasonable film thicknesses, signals on the order of 10's of mV per degree of temperature change can be obtained. For example, a 100 nm film of lithium niobate would provide about 65 mV/° C.

Estimates of the temperature change induced near the heater of the cantilevers by a 10 nm deep bit are in the range of a few degrees or more. (This is highly dependent on the size and geometry of the cantilever but models indicate that manufacturable geometries will provide at least a few degree temperature change). Thus, a pyroelectric readout can provide signals that are a substantial fraction of a volt for 10 nm deep bits.

An estimate of the achievable signal-to-noise ratio (SNR) can be obtained by using the detectivity, D′, for commercial pyroelectric detectors. Typically, D′˜10⁸ cm-rt(Hz)/Watt. This implies a noise equivalent power (NEP)˜rt(A)/D′˜10⁻⁸ rt(A), where A is the area of the pyroelectric detector. If A˜2 um², a reasonable area, then NEP˜1.4 e-12 Watts/rt(Hz). Assuming a bandwidth of 1 MHz, which provides a reasonable overall data rate in a device that has hundreds of probes active at any given point in time, then NEP˜1.4 nW. Estimates of the change in heat load on a cantilever due to a 10 nm deep bit range up to many μWatts. Thus, large SNR's are possible. It is also advantageous to keep the area of the pyroelectric element small to minimize capacitance and thereby maintain a high readout bandwidth.

There are many ways to design a voltage sense circuit to monitor voltages changes induced across the pyroelectric element. For example, the voltage sense circuit 305 can include a FET that is gated by the voltage developed across the pyroelectric element. However, one of ordinary skill in the art will readily recognize that a variety of voltage sense circuit configurations could be employed while remaining within the spirit and scope of the present invention.

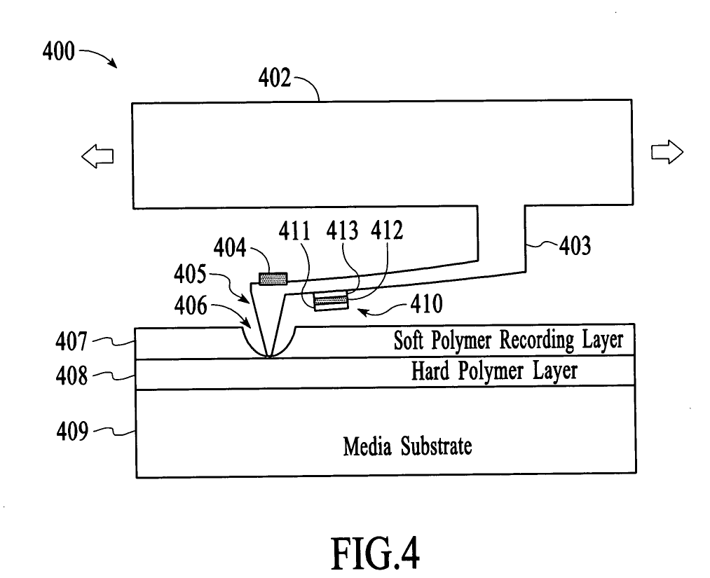

Alternatively, the pyroelectric sensing mechanism can be placed on the “bottom” of the cantilever. FIG. 4 is an illustration of a data storage system 400 in accordance with an alternate embodiment. Similar to system 200 (FIG. 2) data storage system 400 includes a suspension mechanism 402 that includes a cantilever 403. A probe tip 405 is coupled to the cantilever 403 and a heater 404. The system 400 also includes two polymer layers 407, 408. The first polymer layer 407 serves as a data storage medium whereby data is stored on the first polymer layer 407 in the form of a bit 406.

Unlike, the system 200 however the pyroelectric sensing mechanism 410 is on the bottom of the cantilever 403 and includes a top conductor 411, a pyroelectric element 412 and a bottom conductor 413. The advantage of this embodiment is that there is more direct thermal conduction between the pyroelectric element 412 and the storage medium 407. As a result, the pyroelectric element 412 is more sensitive to temperature changes in the gap between the cantilever 403 and the storage medium 407.

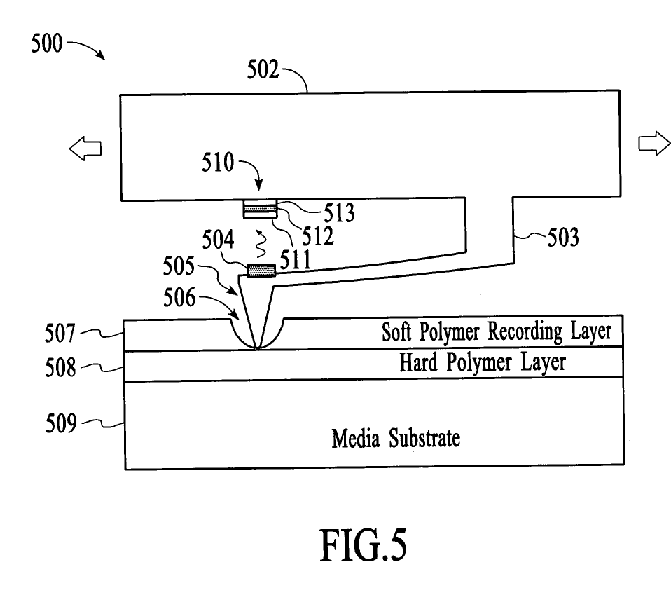

It is also possible to move the pyroelectric element off of the cantilever and onto the supporting suspension mechanism. FIG. 5 is an illustration of a data storage system 500 in accordance with another embodiment. Similar to system 200 (FIG. 2) data storage system 500 includes a suspension mechanism 502 that includes a cantilever 503. A probe tip 505 is coupled to the cantilever 503 and a heater 504. The system 500 also includes two polymer layers 507, 508. The first polymer layer 507 serves as a data storage medium whereby data is stored on the first polymer layer 507 in the form of a bit 506. Unlike, the system 200 however the pyroelectric sensing mechanism 510 is on the suspension mechanism 502 and includes a top conductor 511, a pyroelectric element 512 and a bottom conductor 513.

With this embodiment, changes in the temperature of the heater 504 and the suspension can be monitored with the pyroelectric sensing mechanism 510 via a combination of blackbody radiation and heat conduction through the gas (not shown) that separates the heater 504 and the suspension 502. Essentially, everything radiates blackbody radiation at all times. The amount of heat radiated by a “body” goes up with temperature (as the fourth power of the temperature) and also depends on certain material properties (e.g. a blackbody coefficient). Consequently, the “hot” portions of the cantilever 503 will radiate heat, some of which will be intercepted by the pyroelectric element 512 thereby causing the pyroelectric element 512 to heat up. (The pyroelectric element 512 will also be radiating heat, but at a much lower level because it is much cooler than the heated cantilever 503).

However, at practical temperatures, blackbody radiation will not be the dominant mechanism by which the pyroelectric element 512 is heated or by which the cantilever 503 will lose heat. The dominant heat conduction mechanism will be conduction through whatever gas is present in the device. Typically, the device will be hermetically sealed with some gas inside. In the embodiment of FIG. 5, when the tip 505 drops into the bit 506, the “hot” portions of the cantilever 503 move closer to the storage medium 507 and more heat is conducted through the gas to the storage medium 507. Therefore, the temperature of the cantilever 503 drops. At the same time, less heat is transferred to the pyroelectric sensor 510 both because the sensor 510 is farther away from the cantilever 503 (so that the thermal conductance through the gas is lower) and because the cantilever 503 is cooler.

This approach has the advantage that the pyroelectric element 512, along with the contacts 511, 513 and connecting traces does not need to be built onto the cantilever 503. However, the signals are weaker. This assumes that the gap between the cantilever 503 and the suspension mechanism 502 is large compared to the nominal gap between the cantilever 503 and storage medium 507. However, this is not problematic if the thermal conductance between the pyroelectric element 512 and the suspension mechanism 502 can be made small. Additionally, in this embodiment, the heat capacity of the pyroelectric element 512 should be reasonably small in order to accommodate high bandwidths.

By way of example, if the radiating area of the probe/heater/suspension is 10 μm² and the nominal temperature is about 300° C., then the total change in blackbody radiation for a 10° C. temperature change is only ˜4 nW. Even if the gap between the detector and the thermally radiating surfaces of the probe/suspension is small compared to the lateral dimensions of the radiating surface, the detector should be at least as large as the thermally radiating surface to capture most of the radiation.

In this example, if the detector is 10 μm² then its NEP is approximately 3 e⁻¹² W/rt(Hz). This results in 3 nW of noise in a 1 MHz bandwidth, so the SNR is not much more than one even for a 10° temperature change at 300° C. for an ideal blackbody. If more probes can be implemented so that a lower bandwidth per probe is acceptable, then the readout scheme of this embodiment is possible through blackbody radiation alone.

However, much larger signals are possible by relying on thermal conduction through an ambient gas, particularly if the gap between the cantilever/suspension and the pyroelectric sensor can be kept small. As in the other embodiments, the thermal conductance through the gap can be made more sensitive to the gap by choosing the proper ambient gas and/or using a higher gas pressure. Gas molecules with a shorter mean free path and/or a larger number of internal degrees of freedom will provide a thermal conductance that is more sensitive to changes in gap, particularly in the regime where the gap is close to (or less than) the mean free path of the gas molecules.

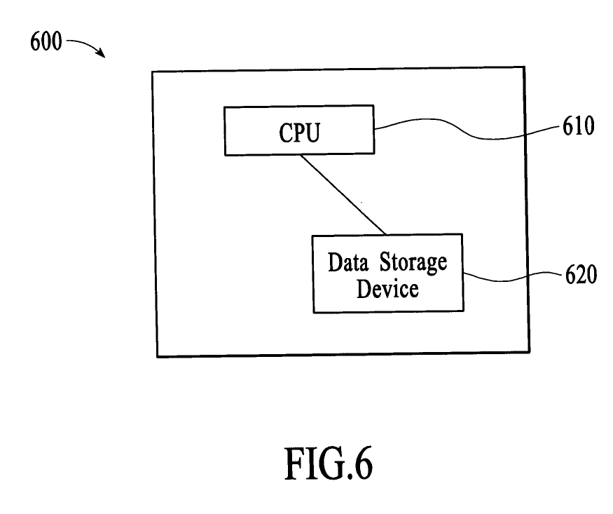

Another embodiment of the present invention includes a computer system that implements a data storage device in accordance with the present invention. FIG. 6 shows a computer system 600 in accordance with an alternate embodiment of the present invention. The computer system 600 includes a central processing unit (CPU) 610 coupled to a data storage device 620. It should be understood that the data storage device 620 could be one of the above-described embodiments of data storage devices.

A data storage device and a method of reading data in a data storage device have been disclosed. Accordingly, a pyroelectric sensing mechanism is implemented within the data storage device in conjunction with a probe tip. As the probe tip is scanned over a data storage medium, a gap between the tip and the underlying storage medium varies as the tip encounters bits in the storage medium. As the gap between the tip and the underlying storage medium changes, a monitorable change in temperature can be detected by utilizing the pyroelectric sensing mechanism. Accordingly, a readout scheme can be implemented whereby the change in temperature and, thereby, the presence of bits in the data storage medium, is monitored with the pyroelectric sensing mechanism.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims which follow.

1. A data storage device comprising:
a probe tip on a flexible suspension mechanism;
a data storage medium proximate to the probe tip; and
a pyroelectric sensing mechanism coupled to the probe tip for sensing a displacement of the probe tip by the data storage medium.

2. The data storage device of claim 1 wherein the data storage medium comprises a polymer material.

3. The data storage device of claim 1 wherein the movement of the probe tip is based on a topography of the data storage medium.

4. The data storage device of claim 1 wherein the pyroelectric sensing mechanism includes a pyroelectric element.

5. The data storage device of claim 4 wherein the pyroelectric element comprises at least one of lithium tantalite and lithium niobate.

6. The data storage device of claim 4 wherein the sensing mechanism further comprises a top and bottom conductor.

7. The data storage device of claim 6 wherein the data storage device further comprises a voltage sensor coupled to the pyroelectric element.

8. The data storage device of claim 1 wherein the flexible suspension mechanism comprises a flexible cantilever.

9. The data storage device of claim 8 wherein the pyroelectric sensing mechanism is coupled to the flexible cantilever.

10. A method of reading data in data storage device comprising:
providing a data storage medium;
bringing a probe tip into contact with the data storage medium via a suspension mechanism; and
sensing a displacement of the probe tip by the data storage medium with a pyroelectric sensing element.

11. The method of claim 10 wherein the data storage medium comprises a polymer material.

12. The method of claim 10 wherein the movement of the probe tip is based on the topography of the data storage medium.

13. The method of claim 10 wherein the pyroelectric sensing mechanism includes a pyroelectric element.

14. The method of claim 10 wherein the probe tip is mounted on a flexible suspension mechanism.

15. The method of claim 13 wherein the pyroelectric element comprises at least one of lithium tantalite and lithium niobate.

16. The method of claim 13 wherein the sensing mechanism further comprises a top and bottom conductor.

17. The method of claim 16 wherein the pyroelectric sensing mechanism is coupled to the flexible suspension mechanism.

18. A data storage system comprising:
means for providing a data storage medium;
means for suspending a probe tip over the data storage medium via a suspension mechanism; and
means for sensing a displacement of the probe tip by the data storage medium with a pyroelectric sensing element.

19. The system of claim 18 wherein the data storage medium comprises a polymer material.

20. The system of claim 18 wherein the displacement of the probe tip is based on the topography of the data storage medium.

21. The system of claim 18 wherein the pyroelectric sensing mechanism includes a pyroelectric element.

22. The system of claim 18 wherein the pyroelectric element comprises lithium tantalate.

23. The system of claim 18 wherein the pyroelectric element comprises lithium niobate.

24. A computer system comprising:
a central processing unit; and
a data storage device coupled to the central processing unit comprising:
a probe tip;
a data storage medium proximate to the probe tip; and
a pyroelectric sensing mechanism coupled to the probe tip for sensing a displacement of the probe tip by the data storage medium.

25. The system of claim 24 wherein the displacement of the probe tip is based on the topography of the data storage medium.

26. The system of claim 24 wherein the pyroelectric sensing mechanism includes a pyroelectric element.

27. The system of claim 24 wherein the pyroelectric element comprises at least one of lithium tantalite and lithium niobate.
